(19) United States
(12) Patent Application Publication
(10) Pub. No.: US 2008/0127727 A1
(43) Pub. Date: Jun. 5, 2008

(54) Piezoelectric Sensor Comprising a Thermal Sensor and an Amplifier Circuit

(75) Inventors: Bernhard Brunner, Veitshochheim (DE); Dieter Sporn, Hameln (DE); Gerhard Domann, Hochberg (DE); Peter Spies, Herzogenaurach (DE); Frank Forster, Erlangen (DE); Javier Gutierrez Boronat, Erlangen (DE); Ruth Houbertz-Krauss, Werneck (DE)

Correspondence Address: KAPLAN GILMAN GIBSON & DERNIER L.L.P., 900 ROUTE 9 NORTH, WOODBRIDGE, NJ, 07095, US

(73) Assignee: Fraunhofer-Gesellschaft Zur Forderung Der Angewandten Forschung E.V., Munchen (DE)

(21) Appl. No.: 11/815,150

(22) PCT Filed: Feb. 14, 2006
(86) PCT No.: PCT/EP06/01336

§ 371 Date: Sep. 24, 2007

(30) Foreign Application Priority Data
Feb. 14, 2005 (DE) 10 2005 006 666.6

(51) Int. Cl. G01P 15/09

(52) U.S. Cl. 73/514.34

(57) ABSTRACT

The invention relates to a piezoelectric sensor which comprises a piezoelectric measuring transducer, an amplifier circuit and also at least one connection for external current or signal lines, these elements being integrated on or in a carrier structure. The sensor thereby enables measurement under different temperature conditions. The piezoelectric sensor according to the invention is used for oscillation, acceleration or deflection measurement, in particular in mechanical engineering, in air and space travel or in the automobile industry.

### BACKGROUND

The invention relates to a piezoelectric sensor which comprises a piezoelectric measuring transducer, an amplifier circuit and also at least one connection for external current or signal lines, these elements being integrated on or in a carrier structure. The sensor thereby enables measurement under different temperature conditions. The piezoelectric sensor according to the invention is used for oscillation, acceleration or deflection measurement, in particular in mechanical engineering, in air and space travel or in the automobile industry.

Piezoelectric sensors have been used for many years in the field of oscillation measurement, acceleration detection and measurement of the smallest deflections in mechanical engineering, air and space travel and in the automobile industry. In the case of piezoelectric materials, the conversion of mechanical deformations into an electrical charge (direct piezoelectric effect) and conversely likewise the expansion of the piezoelectric material when applying an electrical field can be used. The composition PbZrTiO₃ (PZT) in different dopings is industrially most widespread.

Piezoelectric measuring transducers comprise materials which can form electrodes and are contactable, e.g. made of quartz, aluminium nitride (ALN), PbZrTiO₃ (PZT), ceramics or a piezoelectric polymer, such as polyvinylidene fluoride (PVDF), in various geometrical dimensions and forms. They can therefore be present as ceramic discs, as thin films as layers on the most varied of metallic, semiconducting or insulating substrates, as fibres, e.g. embedded in a synthetic resin matrix, as small tubes or rods. According to the case of use, flexible or rigid measuring transducers are preferred.

The piezoelectric elements can cover a very wide frequency spectrum from virtually static processes to several MHz as sensors and actuators. The use as sensor of piezoelectric materials as ultrasonic converters for medical or material-testing purposes is widespread.

Because of the high sensitivity to mechanical deformations and the very rapid response behaviour, the piezoelectric measuring transducers are used in combination with a corresponding electronic amplifier circuit also as acceleration sensors, e.g. as impact sensors in automotive vehicles.

Piezoelectric measuring transducers for measuring expansion, pressure, force or acceleration made from different materials are known in various sizes, geometries, e.g. layers, discs, fibres, pipes, or construction forms (WO 90/13010). Versions of gluing, mechanical clamping or incorporating in structures, e.g. made of composite materials, which can be achieved in any manner for attachment as a function of the measuring object geometry, material, loading, are known (WO 99/26046).

Charge amplifiers as charge, current, voltage converters, mostly as operation amplifier circuits, can be used in the measuring appliance field as modular solutions, e.g. Co. Kistler or BRUEL & Kjaer or MMF. Range switching can be effected via a change in capacitance in the electronic circuit or by switching individual measuring transducers on or off. The electronic amplifier circuits or converters can also be temperature-compensated, as a result of which a change in the amplification behaviour as a function of the temperature of the amplifier circuit is avoided. Additional drive circuits for long measuring lines are likewise already known (EP 0 551 538, U.S. Pat. No. 4,157,510, EP 0 768 533) A temperature compensation of the charge drift as a result of the pyroelectric effect is achieved by arrangement of a plurality of measuring transducers one behind the other or by an electronic high-pass circuit (U.S. Pat. No. 5,095,751, DE 68 905 913).

Integration and combination both with respect to the measuring transducer with the amplifier and to the complete sensor on or in the measuring object is known from the special field of Atomic Force Microscope (AFM) technology (WO 96/08701). A temperature compensation cannot however be deduced from the system described here.

### SUMMARY OF THE INVENTION

Starting herefrom, it was the object of the present invention to provide a sensor system which enables the greatest possible integration of components, which leads to a miniaturised and very economical embodiment of a piezoelectric sensor. A sensor of this type is intended to be able to be adapted to any measuring objects with respect to size and form so that for example even very flat sensor elements are made possible.

According to the invention, a piezoelectric sensor is provided, which has a carrier structure, at least one piezoelectric measuring transducer, an amplifier circuit and also at least one connection for external current and/or signal lines.

A particular feature of the sensor according to the invention is that a thermosensor is contained at the same time and the amplifier circuit contains a temperature compensation. It is made possible as a result that variable temperature conditions in the environment can be taken into account with the amplifier circuit.

The integration of all the previously described components of the piezoelectric sensor on one carrier presents the great advantage of providing a measuring system with high mechanical flexibility, the smallest constructional size and minimum costs. The economical manufacture is hereby attributable in particular to the amplifier circuit which can be produced by semiconductor technology. The temperature compensation of the charge signal which originates from the piezoelectric measuring transducer makes the system insensitive to temperature variations during the measurement.

The miniaturised construction and possibly the mechanical flexibility enable integration of the sensor in composite components or application of the sensor on any measuring objects, without greatly influencing the mechanical quality or form thereof.

The arrangement of the described components of the sensor, i.e. of the measuring transducer, amplifier circuit, connection, sensor line and temperature sensor is arbitrary if the requirements with respect to miniaturisation of the sensor are met.

Preferably, an operation amplifier circuit is a component of the sensor as an amplifier circuit. Said sensor is based on semiconductor circuits which can be produced by means of semiconductor technologies.

Preferably, the amplifier circuit has an additional adaptation and driver step which makes it possible to be able to connect to the sensor also long current and/or signal lines of the most varied construction and with the most varied of electrical characteristics, e.g. with respect to capacitance or impedance.

The amplifier circuit preferably comprises a plurality of individual amplifier steps.

The capacitance of the amplifier circuit is thereby achieved by a particular circuit, a so-called capacitance multiplier, comprising a further operation amplifier and comparatively compact still integratable wiring, the step behaves like a condenser, the nominal value of which can be greater by up to the factor 100 than the output capacitance.

Basically all materials which permit miniaturisation of the sensor are suitable as carrier structure. Materials are thereby preferred as carrier structure which permit a simple and economical production. There should be mentioned as preferred materials here, e.g. plastic material, metal, semiconductors or ceramics.

The at least one measuring transducer comprises a piezoelectric material. Preferably it thereby comprises quartz, ZnO, AlN, PbZrTiO₃ (PZT) or a piezoelectric polymer, in particular polyvinylidene fluoride (PVDF). The measuring transducer can thereby be constructed both from one layer (unimorph), two layers (bimorph) or a plurality of layers (multimorph). There are no restrictions with respect to the geometry of the measuring transducer, rather these can be adapted arbitrarily to the purpose of use. Thus a measuring transducer can be present e.g. in the form of a disc, as a thin film, as a fibre, as a small tube or also as a rod.

It is likewise possible that a plurality of measuring transducers is disposed on the carrier structure.

The piezoelectric measuring transducers are preferably connected by the shortest distance to the amplifier circuit. In a preferred variant, the measuring transducers and the amplifier circuit are arranged one above the other, e.g. in different layers. The spacing can thereby be in the range between 1 μm and to 10 mm. Another preferred variant provides that measuring transducer and amplifier circuit are disposed laterally, i.e. adjacently in one plane. The spacing between measuring transducer and amplifier circuit can hereby be in the range between 10 μm to 100 mm. In this way, electromagnetic interference can be reduced to a minimum.

In order to adapt to the size and form of the measuring object or for integration into a composite component, the piezoelectric sensor is configured to be thin and mechanically flexible or reshapable. However any piezoelectric measuring transducers can be connected to the amplifier circuit.

A further preferred variant provides that the sensor has a connection, via which an external voltage source can be connected. For this purpose, both a direct voltage and an alternating voltage source is possible. The voltage source thereby serves to change the amplification of one or more amplifier steps in the amplifier circuit. In this way, calibration or re-calibration is made possible at any time. This is hence also possible if the sensor according to the invention is already integrated in a measuring object or composite component.

The sensor according to the invention can be produced by conventional methods of construction and connection technology and the individual components can be applied for example by gluing processes, die-bonding and bump techniques, e.g. as a flip chip, and also by wire-bonding processes.

In order to protect the sensor and in particular the electronics from mechanical, thermal and chemical, and here in particular corrosive stresses, thin layers can be applied on the sensor for passivation. These can comprise for example an elastomer, a thermoplast, a thermoplastic elastomer or a duromer. Another preferred variant provides that a thin layer comprising an inorganic-organic hybrid polymer, as is described in WO 93/25604 is applied. The coating can thereby be effected for example in the immersion method. By means of layers of this type, which preferably have a thickness of <10 μm and particularly preferred a thickness of <5 μm, a space-saving passivation of the sensor can be effected.

According to the invention, a composite component is likewise provided which has the previously described piezoelectric sensor according to the invention. Component parts of the composite component can thereby be quite generally metals, wood, glasses, polymers and ceramic materials. In the sense of the present invention, for example a metallic component, e.g. in the form of pipes, should be understood by composite material, on which component the sensor according to the invention is fitted by means of an adhesive connection.

Preferably, the composite component comprises a plastic material or a plastic material laminate. In the field of plastic materials there may be mentioned hereby in particular carbon fibre-reinforced plastic materials (CFK), glass fibre-reinforced plastic materials (GFK) and aramide-reinforced plastic materials.

The piezoelectric sensor according to the invention is used in the field of oscillation, acceleration and/or deflection measurement. Typical fields of application hereby concern mechanical engineering, air and space travel or the automobile industry. A typical example of the use of systems of this type is an impact sensor in automotive vehicles.

### BRIEF DESCRIPTION OF THE DRAWINGS

The subject according to the invention is intended to be explained in more detail with reference to the subsequent Figures without wishing to restrict the latter to the special embodiments described here.

FIG. 1 shows a plan view of a piezoelectric sensor according to the invention.

FIG. 2 shows a side view of a piezoelectric sensor according to the invention.

FIG. 3 shows an electronic circuit variant of the amplifier circuit.

### DETAILED DESCRIPTION OF THE EMBODIMENTS OF THE INVENTION

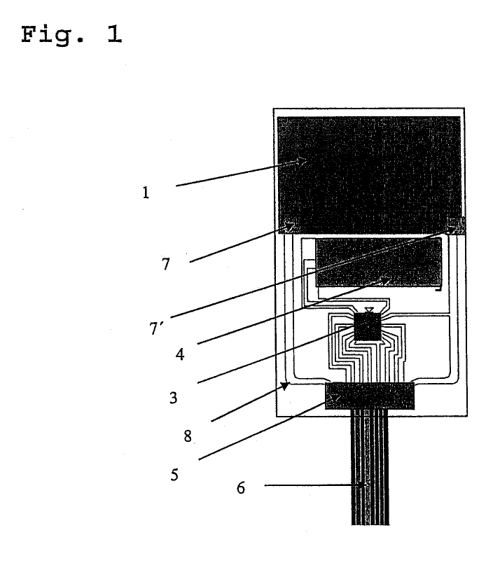

In FIG. 1, a plan view of an electrical sensor according to the invention is represented. A piezoelectric measuring transducer 2 is thereby integrated on the carrier structure 1. As further components, the sensor has an amplifier circuit 3 in the form of a chip. The amplifier circuit can be produced by means of semiconductor technology in an order of magnitude of e.g. approx. 3×3 mm². In addition, a thermosensor 4 is disposed between the measuring transducer and the amplifier circuit. In combination with the temperature compensation which is integrated into the amplifier circuit, measurements can thus be implemented in the environment even under different temperature conditions. Furthermore, the sensor according to the invention has a connection 5, e.g. in the form of a plug contact, to which external current and/or signal lines 6 can be connected. In the case where current and/or signal lines of different constructions and with different electrical characteristics are intended to be connected to the sensor, a driver step is integrated in addition in the amplifier circuit 3. Furthermore, strip conductors 8 which connect the individual components to each other can be detected in the Figure.

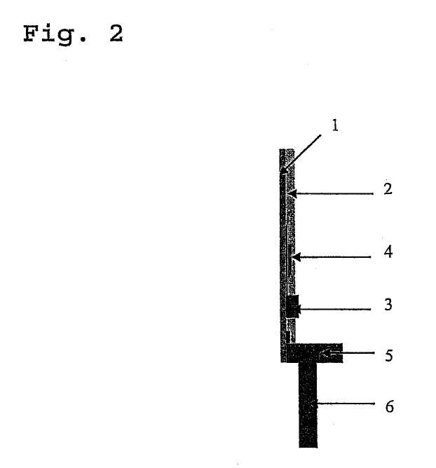

A side view of the piezoelectric sensor according to the invention shown in FIG. 1 is represented in FIG. 2. On the carrier structure 1, which comprises for example plastic material with metal or ceramic, a piezoelectric measuring transducer 2 is disposed. In the present case, the latter comprises a piezoelectric thin layer with a thickness of approx. 2 μm. On the side of the piezoelectric measuring transducer which is orientated away from the carrier structure, an insulation layer which has a thickness of approx. 30 μm is disposed in addition. A further component of the sensor according to the invention is an amplifier circuit in the form of a chip which is approx. 0.3 mm thick. Between the piezoelectric measuring transducer 2 and the amplifier circuit 3, a temperature sensor is disposed, which has a thickness of 0.05 mm in the present case. At the other end of the carrier structure 1, a connection 5 in the form of a plug contact is disposed, to which connection a sensor cable, e.g. a current or signal line, can be connected. Very thin sensors can be produced as a result of the miniaturised construction described here. The variant described here thereby has a thickness of no more than 0.5 mm.

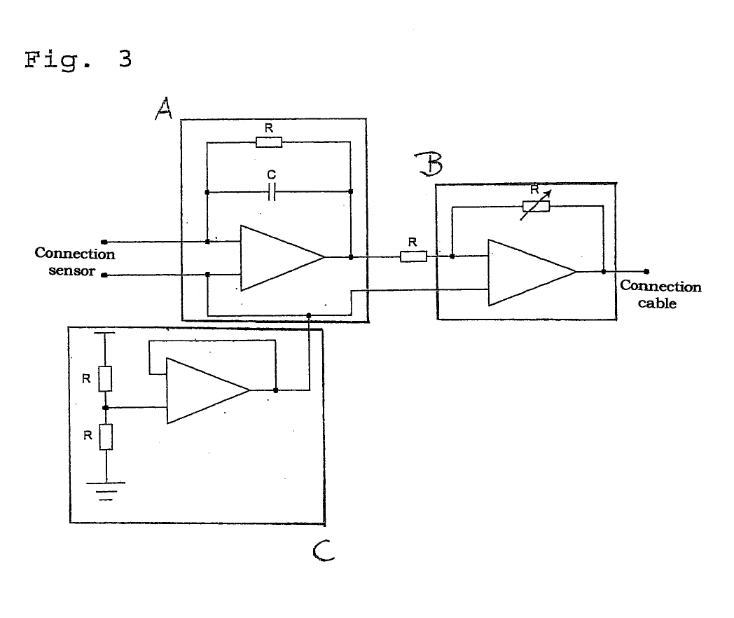

In FIG. 3, a variant of the block diagram of the amplifier circuit is represented. The block diagram thereby comprises three essential elements. The unit A thus comprises the input step which has a charge amplifier. The maximum charge to be processed and the maximum possible output voltage determine the value of the charge condenser via a linear correlation. The time constant from R and C is very large in order to be able to evaluate very low frequencies of the charge signal without amplitude and phase errors.

The amplifier circuit has in addition the unit B. This hereby concerns a precursor step which is constructed from a rail-to-rail operation amplifier. The nominal amplification factor is 1. The nominal value can be chosen to be smaller (damping) or larger (amplification) via an external supplied voltage.

The third essential component of the block diagram relates to the unit C which has a further amplifier. This amplifier produces the common mode voltage (Vdd-2) and hence establishes the operating point of the two other steps.

The cooperation of the three elements described hence represents the integrated charge amplifier.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. Piezoelectric sensor containing a carrier structure (1), at least one piezoelectric measuring transducer (2), an amplifier circuit (3) and also at least one connection for external current and/or signal lines (5),
characterised in that
the sensor has a thermosensor (4) and the amplifier circuit contains a temperature compensation.

2. Piezoelectric sensor according to claim 1,
characterised in that the sensor has a monolithic construction.

3. Piezoelectric sensor according to one of the preceding claims,
characterised in that the amplifier circuit (3) is an operation amplifier circuit.

4. Piezoelectric sensor according to one of the preceding claims,
characterised in that the amplifier circuit (3) has a driver step which enables the connection of long measuring cables.

5. Piezoelectric sensor according to one of the preceding claims,
characterised in that the carrier structure (1) comprises a plastic material, a metal, a semiconductor or a ceramic.

6. Piezoelectric sensor according to one of the preceding claims,
characterised in that the at least one measuring transducer (2) comprises quartz, ZnO, AlN, PbZrTiO₃ (PZT) or a piezoelectric polymer, in particular polyvinylidene fluoride (PVDF).

7. Piezoelectric sensor according to one of the preceding claims,
characterised in that the at least one measuring transducer (2) has a unimorph, bimorph or multimorph construction.

8. Piezoelectric sensor according to one of the preceding claims,
characterised in that the at least one measuring transducer (2) is present in the form of a disc, as a thin film, fibre, small tube and/or rod.

9. Piezoelectric sensor according to one of the preceding claims,
characterised in that the sensor is flexible.

10. Piezoelectric sensor according to one of the preceding claims,
characterised in that the sensor has at least one connection (7, 7′) via which an external voltage source can be connected in order to change the amplification and hence for calibration of the sensor.

11. Piezoelectric sensor according to one of the preceding claims,
characterised in that the sensor has for passivation a thin layer, in particular made of an elastomer, a thermoplast, a thermoplastic elastomer or a duromer.

12. Piezoelectric sensor according to the preceding claim,
characterised in that the thin layer comprises an inorganic-organic hybrid polymer.

13. Composite component containing a piezoelectric sensor according to one of the claims 1 to 12.

14. Composite component according to claim 13,
characterised in that the composite component contains a plastic material or a plastic material laminate.

15. Use of the piezoelectric sensor according to one of the claims 1 to 12 for oscillation, acceleration and/or deflection measurement.

16. Use according to claim 15 in mechanical engineering, in air and space travel and/or in the automobile industry.

17. Use according to one of the two preceding claims as impact sensor in automotive vehicles.
